(19) United States
(12) Patent Application Publication
(10) Pub. No.: US 2011/0008606 A1
(43) Pub. Date: Jan. 13, 2011

(54) FLUORESCENT ANTI-COUNTERFEIT FIBER OF WHICH OPTICAL COLOR IS VARIABLE WITH IRRADIATION ANGLE OF EXCITING LIGHT AND ANTI-COUNTERFEIT MATERIAL

(76) Inventor: Xianlin Sun, Shanghai (CN)

Correspondence Address: WORKMAN NYDEGGER;1000 Eagle Gate Tower, 60 East South Temple, Salt Lake City, UT, 84111, US

(21) Appl. No.: 12/920,043

(22) PCT Filed: Mar. 2, 2009
(86) PCT No.: PCT/CN09/00220

§ 371 Date: Aug. 27, 2010

(30) Foreign Application Priority Data
Feb. 29, 2008 (CN) 200810101204.9

(51) Int. Cl. B32B 27/04; B32B 5/00; D21H 21/40

(52) U.S. Cl. 428/297.4; 428/373; 162/140

(57) ABSTRACT

A fluorescent fiber and an anti-counterfeiting material have an optical color that varies with irradiation angles of exciting light. The anti-counterfeiting fiber includes at least two components of materials that extend parallel along the longitudinal direction without twisting. At least one component contains photoluminescence material. The distribution of the components makes the anti-counterfeit fiber form a shielding structure for exciting light, and has an orientation structure. The exciting light shielding structure and orientation structure enable, when the anti-counterfeit fiber falls freely into a plane paralleled to the horizontal plane, the existence of at least two irradiation angles of exciting light above the plane paralleled to the horizontal plane, from which exciting light irradiates on the anti-counterfeit fiber respectively. The anti-counterfeit fiber thereby displays obvious visual difference between two different luminescent colors. In this manner, the visual characteristic of fluorescent anti-counterfeit fiber cannot be imitated by the printing filament.

### FIELD OF THE INVENTION

The present invention relates to a fluorescent anti-counterfeit fiber of which optical color can be variable with irradiation angle of exciting light and anti-counterfeit material containing said fluorescence anti-counterfeit fiber. More particularly, said fluorescent anti-counterfeit fiber and fluorescent anti-counterfeit fiber appeared on said anti-counterfeit material is the fluorescent fiber of which optical color varies with the irradiation angle of exciting light.

### BACKGROUND OF THE INVENTION

The fluorescent anti-counterfeit fiber paper has been widely used in the field of bank notes, passports, stamps and a variety of securities, but when counterfeiters print fine line with fluorescent ink to imitate visual characteristics of anti-counterfeit fiber paper, the naked eye can not distinguish them. The direct consequences is that counterfeiters can easily keep away from the difficult and complicated paper making process, and use the most simple printing method for imitation. This is a long-standing deficiency we have been eager to eliminate, but this world difficult problem has not been resolved for dozens of years.

Patent CN1412355 describes core-sheath and parallel fibers which are made of dual-band luminescent material. The purpose of said invention is to irradiate said fiber by exciting light with different wavelengths (365 nm and 254 nm respectively) from any angle of incidence. When said fiber in paper is exposed to the single-frequency exciting light at 365 nm of longer-wavelength from any angle of incidence, the fiber displays the color of the longer-wavelength luminescent material. When said fiber in paper is exposed to the single-frequency exciting light at 254 nm of shorter-wavelength from any angle of incidence, the fiber displays the color of the shorter-wavelength luminescent material.

This structure is valueless, because the mixture of shorter wavelength luminescent material and longer wavelength luminescent material can achieve exactly the same visual effect by a simpler single-component spinning. In the same way, counterfeiter can mix shorter-wavelength fluorescent ink with longer-wavelength fluorescent ink, which have the same component, to print fine line having exactly the same visual effect with the above long and short band fluorescence fiber, so the problem of visual characteristics of fluorescent anti-counterfeit fibers being imitated by printing has not been solved.

Embodiment 2 of said patent mentions in passing a kind of parallel round fiber of which two components have the same wavelength (the claims have not asked for protection of this characteristics, so the inventor did not know the possible visual characteristics of this structure).

At first, said patent has not described the unique visual characteristics of this structure—i.e. the changing of irradiation angle of exciting light causes the changing of optical color which is brought by the optical characteristics of this structure. Also it has not described what problem the invention is to address, as well as the effect of this invention. In fact, unless the innovator understands profound luminescence principle of photoluminescence material (or the inventor has concrete practice experience), which is that the photoluminescence material emits light and absorbs exciting light when it is irradiated by exciting light, as well as other series of deduction, it may draw the conclusion that the optical color of fiber with this structure can be variable with the change of exciting angles, it is difficult to imagine such a conclusion only by the structure.

The second, only when the effect of optical color variable with irradiation angles of light can still exist after papermaking, the value can be reflected, so the problem to be resolved at first is that fibers must have uniform orientation after papermaking. In the embodiment of the patent, the fibers are straightening; the orientation of such fibers after papermaking is confused extremely. The specific papermaking experiment shows that only 15% of fibers on surface of paper can produce effect of optical color variable with irradiation angles (without counting the fibers embedded into paper pulp or the fibers deformed during papermaking). This structure of the fibers has no practical value, and is easy to lead to erroneous judgment. Addressing the problem of orientation of fibers during papermaking must follow three logic steps:

1. What shape of fibers has stable orientation?
2. Which orientation of fibers on paper surface has optimal effect of optical color variable with irradiation angles of exciting light?
3. How to make all fibers towards the desired orientation executable in process?

As the inventor of said patent appears to never know that the structure can produce the effect of optical color variable with irradiation angle of exciting light, so the above deduction is impossible.

The third, for the variable color fiber in paper after papermaking, the inventor of present patent concludes by a lot of practices that there are two important factors that affect the effect of optical color variable with irradiation angle when the fibers are used for papermaking. One factor is that, when the fluorescent fibers are embedded in paper pulp layer, the paper fiber around the fluorescent fibers will diffuse the orientating irradiation of exciting light, so that the orientation of actual exciting light irradiating fluorescent fibers changes. The deeper the fluorescent fiber buried in the paper pulp, the more serious the adverse influence of diffuse reflection, and the worse the orientation of exciting light. It will adversely affect the effect of optical variable with irradiation angles and result in the disappearance of the effect of optical color variable with irradiation angles. If this question can not be overcome, it will be worthless for practical purpose. The second factor is that variable color fibers with irradiation angles is subject to compression process during papermaking, the compression process may cause the fibers cross-section become flat section. It will adversely affect the effect of optical color variable with irradiation angles and result in the disappearance of this effect. If it is not overcome, it will be worthless for practical purpose. For the parallel (circular) fiber described in the claims of said invention, after above theoretical analysis and large amount of practices, the parallel structure of the two components is not proved to overcome the effects of two major factors mentioned above.

In summary, said patent does not address this world difficult problem, said patent also did not take this problem as the purpose of the invention, also did not have any specific solution to address this problem.

### SUMMARY OF THE INVENTION

The purpose of this invention is to provide composite fluorescent anti-counterfeit fibers and anti-counterfeit material containing these anti-counterfeit fibers, of which visual characteristics depends on the distribution structure of material components on cross-section and the specially designed material components. When said fluorescent anti-counterfeit fibers are added into the anti-counterfeit materials, the specific distribution structure and specially designed parts can be presented on the surface of the anti-counterfeit material. When the exciting light changes the irradiation angle, the color of fluorescent anti-counterfeit fibers in the anti-counterfeit material will change significantly. This unique visual characteristic is unable to be imitated by printing fine line with fluorescent ink by counterfeiter.

The invention is achieved by:

A fluorescent anti-counterfeit fiber, said anti-counterfeit fiber comprises at least two component materials which are distributed on cross-section and parallel extending along with the longitudinal direction of anti-counterfeit fiber together without twisting, in which at least one component contains photoluminescence material, characterized in that, the distribution of the at least two components of said anti-counterfeit fiber on the cross-section makes said anti-counterfeit fiber form the exciting light shielding structure which can shield the exciting light and directional structure with specific orientation, both of which enable, when said anti-counterfeit fiber falls freely into a plane paralleled to the horizontal plane, the existence of at least two irradiation angles, called angle A and angle B, of exciting light above said plane paralleled to the horizontal plane, from which exciting light irradiates on said anti-counterfeit fiber respectively, and thereby said anti-counterfeit fiber displays obvious visual difference between two different luminescent colors, and said obvious visual difference at least is in one of the following two situations:
(1) When irradiated by the exciting light with angle A, said anti-counterfeit fiber displays luminescent color M, when the anti-counterfeit fiber is irradiated by the exciting light with angle B, the luminescent color displayed by said anti-counterfeit fiber disappeared.
(2) When irradiated by the exciting light with angle A, said anti-counterfeit fiber displays luminescent color M, when irradiated by the exciting light with angle B, said anti-counterfeit fiber displays luminescent color N, wherein said luminescent color M and said luminescent color N display obvious visual difference.

Further, in the scheme mentioned above, the wavelengths of exciting light irradiated from angle A and from angle B can be chosen the same.

Further, the exciting light mentioned above includes but not limited to ultraviolet light and infrared light.

The change of irradiation angle of exciting light resulting in the significant change of the visual characteristics of fluorescent anti-counterfeit fiber can be referred to as “optical color varying with irradiation angle”. The term “component” in this invention is equivalent to the meaning of “the component constituting geometry structure”.

The disclosure and realization of said anti-counterfeit fiber's effect of optical color variable with irradiation angles depend on the material components' distribution on cross-section and special design of all components. When one component of anti-counterfeit fiber containing photoluminescence material is irradiated by exciting light, the nature of luminescence of this component is that said component absorbs the exciting light energy. When the energy of all or most of the exciting light is absorbed by the component containing photoluminescence material, the material around this component can not be irradiated by exciting light, so the effect of optical color variable with irradiation angles can be realized through the selection of material components and the design of distribution. If the optical color of the fiber itself varying with irradiation angles can be achieved, but such effect of fiber, however, disappears after adding this anti-counterfeit material to, such as, paper, the production will have no practical value. One of the important issues to be solved is the uniform and stable orientation of the cross-section of said anti-counterfeit fibers corresponding to the surface of paper layer. It is shown from the theoretical analysis and specific experiment that, when the shielding structure and directional structure of said exciting light enable, when said fibers fall freely to the horizontal plane, the space above said plane to exist at least two irradiation angles A and B of the exciting light with the same wavelength. Then, there exhibits obvious visual difference when said anti-counterfeit fibers are exposed to the irradiation of said two angles, the anti-counterfeit fibers can exhibit obvious visual difference after the anti-counterfeit fibers embedding in paper.

Furthermore, said obvious visual difference of optical color is the difference between color M and no color. This is a typical visual characteristic. In this situation, only one component of said fiber contains photoluminescence material.

Another more typical visual characteristic is that the obvious visual difference is the difference between color M and color N. In this situation, at least two components of said fiber contain luminescence materials with different optical color.

Preferably, said components are made of filaments by molten compound spinning process, rather than coated or printed material. This characteristic makes the preparation of said anti-counterfeit fiber possible for the process. The conclusion is the best choice by present inventor after comparison of a large number of processes (such as printing, coating method, etc.).

Furthermore, the present invention has a very elaborate design. In order to facilitate the recognition, in the above-mentioned program, every material component can be transparent, so that the naked eye can see obvious visual difference of anti-counterfeit fibers at any incident angle. The lose of luminescent light of said anti-counterfeit fiber is minimum. The greatest advantage is that, when the angle of exciting light which is irradiated on said anti-counterfeit fiber is changed, the effect of optical color variable with irradiation angles appears and can be seen in any direction by naked eye, so it is convenient for people to carry out specific identification operation.

To describe easily the distribution of each component of said anti-counterfeit fibers on cross-section, set up a plane coordinate with horizontal X-axis, vertical Y axis taking the geometric center of cross-section said fiber as origin of coordinates. When only one component of the anti-counterfeit fiber contains photoluminescence material, this component containing the photoluminescence material is distributed at the left or right side of midperpendicular plane composed of all Y axises, and is divided symmetrically by X-axis. When anti-counterfeit fibers contain two components with different photoluminescence material, said two components are distributed respectively at lift side and right side of midperpendicular plane composed of all Y axises and be divided symmetrically by the X axis both, wherein said two components with different photoluminescence material have the same wavelength of exciting light but display obvious different optical colors.

In order to facilitate the description of the orientation control of anti-counterfeit fiber, this invention introduces the definition of anti-counterfeit fiber cross-section flattening: the flattening equals to the ratio D/H, wherein the D is the width of anti-counterfeit fiber cross-section in X axis, and the H is the height of the anti-counterfeit fiber cross-section of Y axis.

In order to orientate anti-counterfeit fiber cross-section to a reliable direction after the fibers were buried under the layer of paper pulp, when said anti-counterfeit fiber cross-section flattening is less than 1.5, it is preferably chosen to design into curved fiber, especially directionally curved fiber, which is an optimized directional structure.

In order to directionally curve anti-counterfeit fibers, at least two components with different heat shrinkages of said anti-counterfeit fibers should respectively locate at both sides of the midperpendicular plane composed of Y axis.

Theoretical analysis and the inventor's mass experiments proved that, for oblate anti-counterfeit fiber, when the flattening of fiber is ≦0.7 and said fiber with the cross-section as shown in FIG. 1a is straight, the Y axis of anti-counterfeit fiber as freely-falling body falling on the flat surface parallel to the level is almost 100% parallel to said flat surface. In this situation, irradiation from all angles of incidence above this flat does not change luminescent color of fiber. When the flattening of straight anti-counterfeit fiber is 1, of which cross section is circle as shown in FIG. 2a, the orientations of freely-falling fibers on midperpendicular plane composed of Y axises are random, and have the same possibility of the angle with said flat surface. When falling to said flat surface at the same time, many anti-counterfeit fibers exhibit a little or no effect of optical color variable with irradiation angles. In this situation, only little anti-counterfeit fibers whose midperpendicular plane composed of Y axises is perpendicular to said flat exhibit obvious the effect of optical color variable with irradiation angles. This corresponds to our experiments. If it was not resolved, this invention would have no practical value.

One of the solutions is that: when the flattening of said anti-counterfeit fiber is <1.5, said anti-counterfeit fiber is curved, the Y axises of all cross-sections of fibers turn to curved midperpendicular plane, along with which the anti-counterfeit fibers curve. When said anti-counterfeit fiber freely falls down to said flat surface, the flat surface determined by the curved anti-counterfeit fiber will be 100% parallel to said flat surface, and every midperpendicular plane composed of Y axises of anti-counterfeit fiber is 100% reliable and vertical to said flat surface so as to ensure that all anti-counterfeit fiber in said flat surface will exhibit the best effect of optical color variable with irradiation angles.

Both the theoretical analysis and concrete experiments executed by this inventor proved the fact that the orientation law of the above curved anti-counterfeit fiber free falling to said flat surface is the same with that free falling to the layer of paper pulp.

It is difficult to directionally curve such fine fibers circling Y axis in technic. The inventor resolved this problem skillfully after a long-term research. The method is that at least two components with different heat shrinkages of said anti-counterfeit fibers respectively locate at both sides of midperpendicular plane composed of Y axises. When anti-counterfeit fibers are heated, they circle the midperpendicular plane composed of Y axises reliably. This discovery is a great coincidence. It makes use of the fact that the heat shrinkages of different materials are different. So the anti-counterfeit fiber is cut, then dispersed in water and heated by water, and the curved orientation of said fibers is just along the midperpendicular plane composed of Y axises. Consequently, when anti-counterfeit fibers fall into the layer of pulp, the paper flat surface is vertical to its Y axis. This really guarantees that the specific orientations of each fluorescent anti-counterfeit fiber are the same, and accordingly each anti-counterfeit fiber can exhibit the effect of fluorescence variable with irradiation angles. It makes non-oblate fluorescent anti-counterfeit fiber exhibit the visual effect of optical color variable with irradiation angles after adding anti-counterfeit materials. This technique is the outcome of my two years' contemplation, and it is full of creativity.

Theoretical analysis and mass experiments proved that, when the flattening of said anti-counterfeit fiber cross-section is <1.5, the anti-counterfeit fiber must be curved along with the curved midperpendicular plane composed of all Y axises of anti-counterfeit fibers, in order that said anti-counterfeit fiber falling into the layer of pulp has reliable and directional orientation. When the flattening is ≧1.5 said anti-counterfeit fiber can control the orientation of said anti-counterfeit fiber after it falling into the layer of pulp even if said fiber was straight. Besides, in order to make the anti-counterfeit fiber become straight, the heat shrinkages of every component or at least geometric symmetric components must be the same.

Furthermore, in the above definition of coordinate system, when two components of anti-counterfeit fiber contain photoluminescence materials, in order to specifically describe the shelter capability of the exciting light shielding structure of anti-counterfeit fiber cross section, we defined the shelter ratio here:

Z_{45°}=(1−A_{N}/A_{M})×100%

As shown in FIG. 7, in the formula, Z_{45°} represents that exciting light A's incidence angle to X is 45°;
A_{M} is the vertical irradiated area of the photoluminescence material component displaying luminescent color M;
A_{N} is the vertical irradiated area of the photoluminescence material component displaying luminescent color N.

When Z_{45°} is 100%, the effect of optical color variable with irradiation angles is obvious. When Z_{45°} is 0, the effect of optical color variable with irradiation angles disappears.

With the same shelter ratio, the larger the exciting light A′s incidence angle to X, like Z_{70°}, the better the effect of optical color variable with irradiation angles of anti-counterfeit fiber.

When two components of said anti-counterfeit fiber are photoluminescence material with different luminescent color M and N, respectively, designing selects said anti-counterfeit fiber's shelter ratio Z_{45°} as 100%.

Both theoretical analysis and concrete experiments proved that, when Z_{45°} is less than 100%, the effect of optical color variable with irradiation angles has obvious loss. Especially, when said anti-counterfeit fiber falls into the layer of pulp, such loss becomes more obvious due to the diffuse reflection of paper fiber.

FIG. 2b shows round and paralleled anti-counterfeit fibers of two components, in which the second component's luminescent color is M, and the third component's luminescent color is N, in which the Z_{45°} is 83%, as shown in 7. When said anti-counterfeit fiber falls into the layer of pulp, its effect of optical color variable with irradiation angles is weak due to the addition of the diffuse reflection of paper fiber.

FIG. 3b shows round and paralleled anti-counterfeit fibers cross-section of three components. The ratio of superficial area of each photoluminescence material to the whole fiber superficial area is less than or equal to ¼, in which the Z_{45°} is 100%, as shown in FIG. 8. When said anti-counterfeit fiber falls into the layer of pulp, its effect of optical color variable with irradiation angles is better than that of round and paralleled anti-counterfeit fibers of two components as shown in FIG. 2b, under the same experiment conditions even with the addition of the diffuse reflection of paper fiber.

FIG. 3e shows round and sheath core eccentric anti-counterfeit fiber of three components. The ratio of superficial area of each photoluminescence material to the whole fiber superficial area is less than or equal to ⅛, in which the Z_{45°} is 100%, as shown in FIG. 9. When said anti-counterfeit fiber falls into the layer of pulp, its effect of optical color variable with irradiation angles is better than that of round and paralleled anti-counterfeit fibers of two components as shown in FIG. 2b, under the same experiment conditions, even with the addition of the diffuse reflection of paper fiber.

Besides, because of the pressure of the surrounding paper and the diffuse reflection of the surrounding paper fiber, when anti-counterfeit fiber only contain one-component containing photoluminescence material, the irradiated area of said anti-counterfeit fiber containing photoluminescence material component can be less than ⅖ of the anti-counterfeit fiber's whole superficial area. Furthermore, this ratio can also be less than ⅕, or less than ⅛, or less than 1/10.

The following is a part of the typical structure of anti-counterfeit fiber:

In structure 1, said anti-counterfeit fiber comprises shielding component (1) and luminescent component (2), wherein said shielding component (1), which does not contain photoluminescence material can be penetrable to visible light, but shield the exciting light, and said luminescent component (2) which contains photoluminescence material displays luminescent color M. The superficial area of luminescent component (2) on the surface of anti-counterfeit fiber is not larger than ⅖ of the whole fiber superficial area.

Furthermore, in the above structure 1, when the flattening of said anti-counterfeit fiber is <1.5, said anti-counterfeit fiber is curved, the Y axises of all cross-sections of fibers turn to curved midperpendicular plane, along with which the anti-counterfeit fibers curve. In order to directionally curve anti-counterfeit fibers, shielding component (1) and luminescent component (2), with different heat shrinkages, locate at both sides of midperpendicular plane composed of Y axises.

Furthermore, in the above structure 1, when the flattening of said anti-counterfeit fiber is said anti-counterfeit fiber is straight. In order to make the anti-counterfeit fiber become straight, shielding component (1) and luminescent component (2) have the same heat shrinkage.

In structure 2, said anti-counterfeit fiber comprises luminescent component (2₂) and luminescent component (3₂) by means of parallel combining of said two luminescent components. Said first luminescent component (2₂) contains photoluminescence material with luminescent color M. Said second luminescent component (3₂) contains photoluminescence material with luminescent color N. Luminescent color M and N display obvious visual difference. The superficial area of first luminescent component (2₂) and the second luminescent component (3₂) on the surface of the anti-counterfeit fiber are ½ of the total superficial area, respectively.

In the above structure 2, the exciting light wavelengths of the first luminescent component (2₂) and the second luminescent component (3₂) must be the same. If they are not the same, one component can not shelter the other, and the effect of optical color variable with irradiation angles can be not exhibited. If we choose exciting light materials respectively with the wavelengths, for example, of 254 nm and 365 nm, neither the single wavelength ultraviolet identification light which is common in the market nor double wavelengths exciting light source can exhibit the effect of optical color variable with irradiation angles.

Furthermore, in the above structure 2, when the flattening of anti-counterfeit fiber is <1.5, said anti-counterfeit fiber is curved, the Y axises of all cross-sections of fibers turn to curved midperpendicular plane, along with which the anti-counterfeit fibers curve. In order to directionally curve anti-counterfeit fibers, the first luminescent component (2₂) and the second luminescent component (3₂) with different heat shrinkages respectively locate at the two sides of the midperpendicular plane composed of Y axises.

In the above structure 2, when the flattening of said anti-counterfeit fiber's cross section is ≧1.2, especially when it is ≧1.5, its shelter ratio Z_{45°} decreases rapidly so that the effect of optical color variable with irradiation angles decrease rapidly too. So we can conclude that the structure 2 cannot be oblate, therefore said fiber cannot be designed into straight fiber.

In structure 3, said anti-counterfeit fiber comprises the shielding component (1₃), the first luminescent component (2₃) and the second luminescent component (3₃). Said shielding component (1₃) does not contain photoluminescence material, and it can be penetrable to visible light but shield the exciting light. Said first luminescent component (2₃) contains photoluminescence material with luminescent color M. Said second luminescent component (3₃) contains photoluminescence material with luminescent color N. Luminescent color M and N display obvious visual difference.

Two luminescent components in the above structure 3 preferably are with the same wavelength of exciting light, in order that the demands of the selection of shielding material (1₃) and exciting light source are lower. If their wavelengths of exciting light are different, which are, for example, 254 nm and 365 nm, respectively, the shielding material (1₃) must absorb both wavelengths of exciting light. And exciting light source must send exciting light with two wavelengths at the same time. However, single wavelength exciting light source would have no effect of optical color variable with irradiation angles for structure 3. But nowadays, almost all the widespread ultraviolet identification lights are single wavelength. So, the requests are difficult to meet in practice.

Furthermore, in the above structure 3, when the flattening of anti-counterfeit fiber is <1.5, the chosen anti-counterfeit fiber is curved. The Y axises of all cross-sections of fibers turn to curved midperpendicular plane, along with which the anti-counterfeit fibers curve. In order to curve the anti-counterfeit fibers along with the midperpendicular plane composed of Y axises, the first luminescent component (2₃) and the second luminescent component (3₃) with different heat shrinkages should respectively locate at the two sides of the midperpendicular plane composed of Y axises.

In the structure 3, when the flattening of said anti-counterfeit fiber's cross-section is ≧1.5, said anti-counterfeit fiber is straight. In order to make anti-counterfeit fiber straight, at least the first luminescent component (2₃) and the second luminescent component (3₃) have the same heat shrinkage.

In structure 4, said anti-counterfeit fiber comprises shielding component (1₄), luminescent component (2₄) and transmitting component (4₄). Said shielding component (1₄) does not contain photoluminescence material, which can be penetrable to light but shield the exciting light. Said luminescent component (2₄) contains photoluminescence material with luminescent color M. Said transmitting component (4₄) can be penetrable to exciting light as well as visible light. On cross-section of said anti-counterfeit fiber, profiles of shielding component (1₄) and transmitting component (4₄) are semicircle or semi-oblate, and so on, which are both parallel arranged with the transmitting component (2₄) in the middle of shielding component (1₄) and transmitting component (4₄).

Furthermore, in the above structure 4, when the flattening of anti-counterfeit fiber is <1.5, the chosen anti-counterfeit fiber is curved. The Y axises of all cross-sections of fibers turn to curved midperpendicular plane composed of Y axises, along with which the anti-counterfeit fibers curve. In order to directionally curve anti-counterfeit fibers along with the midperpendicular plane composed of Y axises, the luminescent component (1₄) and transmitting component (4₄) have different heat shrinkages.

In the structure 4, when the flattening of said anti-counterfeit fiber's cross-section is ≧1.5, said anti-counterfeit fiber is straight. In order to make said anti-counterfeit fiber straight, at least the shielding component (1₄) and the transmitting component (4₄) have the same heat shrinkage.

Furthermore, in order to reduce or even eliminate paper fiber diffuse reflection's influence on said anti-counterfeit fiber′ effect of optical color variable with irradiation angles, in the above structure 4, the hardness of the chosen transmitting component (4₄) should be lower than that of said transmitting component (2₄).

In structure 5, said anti-counterfeit fiber comprises the first luminescent component (2₅), the second luminescent component (3₅) and transmitting component (4₅). Said first luminescent component (2₅) contains photoluminescence material with luminescent color M. Said second luminescent component (3₅) contains photoluminescence material with luminescent color N. Luminescent color M and N display obvious visual difference. Said transmitting component (4₅) can be penetrable to exciting light as well as visible light. On said cross-section of anti-counterfeit fiber, profiles of the first luminescent component (2₅) and the second luminescent component (3₅) are respectively semi-oblate and parallel arranged to a whole oblate. The profile of transmitting component (4₅) is circle or oblate, which can be penetrable to exciting light as well as visible light. The flat profile pieced of the first luminescent component (2₅) and the second luminescent component (3₅) is medially contained in the circle or oblate profile of transmitting component (4₅). The long axis of oblate transmitting component (4₅) is parallel to X axis. And the interface of the first luminescent component (2₅) and the second luminescent component (3₅) is vertical to X axis.

In structure 5, for the same principle in the structure 2, the first luminescent component (2₅) and the second luminescent component (3₅)'s exciting light wavelengths must be the same.

Furthermore, in the above structure 5, when the flattening of anti-counterfeit fiber is <1.5, the chosen anti-counterfeit fiber is curved. The Y axises of all cross-sections of fibers turn to curved midperpendicular plane, along with which the anti-counterfeit fibers curve. In order to directionally curve anti-counterfeit fibers, the first luminescent component (2₅) and the second luminescent component (3₅) should have different heat shrinkages.

Furthermore, in the structure 5, when the flattening of said anti-counterfeit fiber's cross-section is ≧1.5, said anti-counterfeit fiber is straight. In order to make anti-counterfeit fiber straight, at least the first luminescent component (2₅) and the second luminescent component (3₅) have the same heat shrinkage.

Furthermore, in order to reduce or even eliminate paper fiber diffuse reflection's influence on said anti-counterfeit fiber′ effect of optical color variable with irradiation angles, in the above structure 5, the hardness of the chosen transmitting component (4₅) should be lower than that of said the first luminescent component (3₅).

In structure 6, said anti-counterfeit fiber comprises the shielding component (1₆), first luminescent component (2₆), the second luminescent component (3₆) and the transmitting component (4₆). Said shielding component (1₆) contains photoluminescence material which can be penetrable to visible light but shield exciting light. Said first luminescent component (2₆) contains photoluminescence material with luminescent color M. Said second luminescent component (3₆) contains photoluminescence material with luminescent color N. Luminescent color M and N display obvious visual difference. Said the transmitting component (4₆) can be penetrable to exciting light as well as visible light. The shielding component (1₆) locates between the two parts of the transmitting component (4₆) and they are parallel to compose two interfaces. Said interfaces are vertical to X axis. The first luminescent component (2₆) and the second luminescent component (3₆) respectively locate in the middle of the two interfaces. The first luminescent component (2₆) and the second luminescent component (3₆) have different heat shrinkages so as to bend said anti-counterfeit fiber along with the midperpendicular plane composed of Y axises.

In order to further facilitate the identification, said curved fiber bends to be a close ring circling along the direction of anti-counterfeit fiber's length. If said curved fiber is irradiated by the exciting light from any angle under this condition, the semicircle which is near to the exciting light source sends a light of which luminescent color is different from that of the other semicircle far from the exciting light source. In another case, the semicircle which is near to the exciting light source dose not send light, meanwhile the other semicircle far from the exciting light source exhibits an luminescent color. This is a kind of unique visual characteristic which can facilitate the operation of identification. If the fiber is straight or slightly curved, the irradiation angle of the exciting light must be basically vertical to the direction of fiber length, so that said fiber can exhibit obvious effect of optical color variable with irradiation angles. The close ring fiber solves above difficult problem, the close ring fiber can exhibit the effect of optical color variable with irradiation angles even if the exciting light irradiates at all direction. Said close ring anti-counterfeit fiber makes the operation of identification more convenient and more flexible.

Theoretical analysis and concrete experiment proved that when the flattening of anti-counterfeit fiber's cross-section is ≧1.5, said anti-counterfeit fiber could be a line rather than a curve, the origination of said anti-counterfeit fiber falling into the layer of paper pulp can be controlled stably.

An anti-counterfeit material which contains fluorescence anti-counterfeit fiber is paper or plastic film, characterized in that, proper selections of structure distribution of components on said cross-section of the fluorescence anti-counterfeit fiber composing said anti-counterfeit material, optical properties of all components and the relative position between the cross section of said anti-counterfeit fiber and the surface of said anti-counterfeit material give rise to at least two irradiation angles of the exciting light on a surface, in which exciting light irradiating the same anti-counterfeit fiber of said anti-counterfeit material from said two irradiation angles causes obvious visual difference.

Furthermore, said anti-counterfeit material contains all the anti-counterfeit fibers mentioned in the above anti-counterfeit material scheme. All said anti-counterfeit fibers can exhibit the effect of optical color variable with irradiation angles when said anti-counterfeit fibers fall into the layer of paper pulp.

In order to eliminate or reduce the influence of the diffuse reflection of paper fiber on the effect of optical color variable with irradiation angles of said anti-counterfeit fibers which embedded deeply into the layer of paper pulp, said shielding component of said anti-counterfeit fibers is added into the layer of paper pulp to shield the diffuse reflection of paper fiber.

Furthermore, the shielding component of exciting light is titanium white. Titanium white is not only a kind of whitening material which increases the covering ability of paper, but also an excellent material absorbing ultraviolet.

The content of said titanium white in the layer of paper pulp is not less than 4%, preferable, not less than 5%.

The shielding component also can be other exciting light absorber with other properties, like UV327, etc.

Paper fiber also can be dyed or wrapped of exciting light absorber to shield exciting light.

For multi-layer paper pulp paper or paperboard, the shielding component only needs to be added to the layer of paper pulp that contains fluorescence anti-counterfeit fiber to save the cost.

Besides, in order to eliminate the influence of the diffuse reflection of the paper fiber, said paper can be composed of at least two layers of paper pulp, wherein the ration of paper pulp that contains anti-counterfeit fiber should be not larger than 30 g/m² so as to reduce and even eliminate the adverse impact of the diffuse reflection of paper fiber on the effect of optical color variable with irradiation angles of the fluorescence anti-counterfeit fiber.

Said paper also can be composed of at least two layers of paper pulp, wherein anti-counterfeit fiber is in the middle of surface layer and other layer of paper pulp. The ration of the surface layer of paper pulp should be not larger than 25 g/m².

Furthermore, said anti-counterfeit material is paper, characterized in that, said paper is composed of at least three layers of paper pulp, in which the layer of paper pulp that contains anti-counterfeit fiber distributes between the surface layer of paper pulp and other layers of paper pulp. The ration of the surface layer of paper pulp should be not larger than 25 g/m². The ration of the layer of paper pulp that contains anti-counterfeit fiber should be not larger than 20 g/m².

Plastic film has no influence of diffuse reflection on the effect of optical color variable with irradiation angles.

### INVENTION EFFECT

1. This invention solves the universal problem that the visual characteristic of fluorescence anti-counterfeit fiber is easy to be imitated by the printing filament. Adopting this invention can prevent the counterfeit from rounding the superior difficulty papermaking threshold.
2. In this invention, the inventor skillfully makes use of two materials that have different heat shrinkage to creatively solve the problem of directional bending anti-counterfeit fiber, which makes the operation of directional curving fiber more convenient.
3. This invention adopts the design that every component is transparent by visible light in order to make naked eye be able to conveniently observe the obvious effect of optical color variable with irradiation angles of fluorescence anti-counterfeit fiber from any angle.
4. Based on the profound understand of the existing situation of spinning equipment, this invention designs straight anti-counterfeit fiber with oblate cross section (D/H≧1.5) exhibiting optical color variable with irradiation angles (only the visual difference from luminescent color M to N). This kind of fiber could only be made by three-component spinning equipment. However, the spinning equipment does not exist now, and it must be specialized made so that the equipment corresponding to such structure could be owned exclusively. This is good for controlling the source of the fiber producing, and furthermore increasing the effect of anti-counterfeiting.
5. The color changing of said fiber exhibiting optical color variable with irradiation angles does not only relies on the shape of three-dimensional section formed by fiber components, but also relies on the irradiation direction of the exciting light. So when the anti-counterfeit fiber falls into the layer of paper pulp, it faces two limits. The first limit is that the pressure of papermaking would make anti-counterfeit fiber's cross section oblate. The second limit is that the more paper fibers cover said fluorescent anti-counterfeit fibers, the larger the influence of the diffuse reflection of paper fiber on the direction changing of the exciting light, because the diffuse reflection of paper fiber around fluorescent anti-counterfeit fibers to the exciting light can change exciting light direction In order to reduce the influence of the above two factors, the inventor adopts and selects many special design of fiber cross section in this invention by repeating experiment and analysis, to reduce or even eliminate the influence of the above two factors and make it able to apply in practice.

### BRIEF DESCRIPTION OF THE DRAWINGS

FIG. 1a, FIG. 1b, FIG. 1c, FIG. 1d, FIG. 1e and FIG. 1f show cross sections of two-component anti-counterfeit fiber which contains a component of photoluminescence material.

FIG. 2a and FIG. 2b show cross sections of two-component anti-counterfeit fiber which both contain photoluminescence material.

FIG. 3a, FIG. 3b, FIG. 3c, FIG. 3d, FIG. 3e and FIG. 3f show cross sections of three-component anti-counterfeit fiber which contains two components of photoluminescence materials.

FIG. 4a, FIG. 4b, FIG. 4c and FIG. 4d show the cross sections of three-component anti-counterfeit fiber which contains a component of photoluminescence material, a component of exciting light absorber and a component of transparent material.

FIG. 5a, FIG. 5b, FIG. 5c, FIG. 5d, FIG. 5e and FIG. 5f show the cross sections of three-component anti-counterfeit fiber which contains a component of transparent material, and two components of different photoluminescence materials.

FIG. 6 shows the cross section of four-component curved anti-counterfeit fiber, which contains a component of transparent material, a component of exciting light absorber and two components of photoluminescence materials with different heat shrinkages

FIG. 7, FIG. 8 and FIG. 9 show sketch maps of exciting light shelter ratio of all cross sections of anti-counterfeit fiber.

FIG. 10 shows the section sketch map of anti-counterfeit paper distributed by anti-counterfeit fiber.

### DETAILED DESCRIPTION OF THE PREFERRED EMBODIMENTS

### Embodiment 1

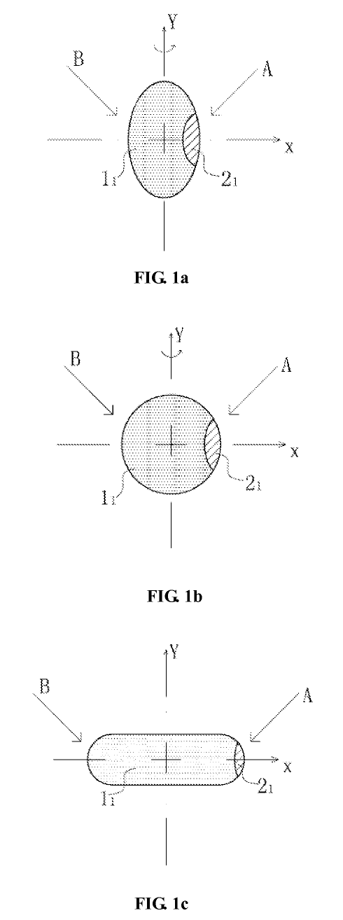

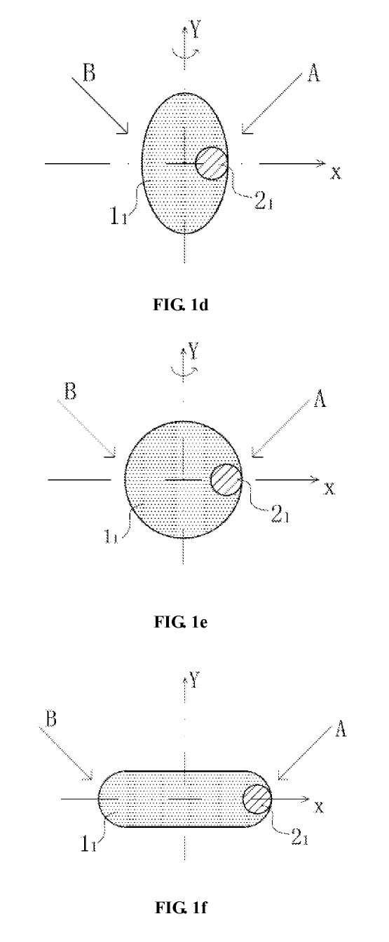

FIG. 1a, FIG. 1b, FIG. 1c, FIG. 1d, FIG. 1e and FIG. 1f show cross sections of two-component anti-counterfeit fiber which contains a component of photoluminescence material.

The cross section of the anti-counterfeit fiber comprises shielding component 1 and luminescent component 2₁. These two components are parallel distributed in the cross section and parallel extended without twisting to the longitudinal direction of the fiber. The shielding component does not contain photoluminescence material, but contains exciting light absorber which can be penetrable to visible light but shield exciting light. The absorption spectrum of absorbing material at least covers the excitation wavelength of the luminescent material. The luminescent component 2₁ contains photoluminescence material whose luminescent color is M which locates at the side of Y axis of the midperpendicular plane. The X axis which is the horizontal axis of cross section equally divides the cross section of photoluminescence material with luminescent color M. Preferably, the area of luminescent component 2₁ on the surface of the anti-counterfeit fiber should be not larger than ⅖ of the whole fiber surface area.

In the anti-counterfeit fiber shown in FIG. 1a, FIG. 1b, FIG. 1d and FIG. 1e, the flattening of the cross section of anti-counterfeit fiber is ≦1. The anti-counterfeit fiber is directionally bended along the midperpendicular plane composed of Y axises, and the Y axises of all cross-sections of fibers turn to curved midperpendicular plane composed of Y axises. Shielding component 1₁ and luminescent component 2₁ should have different heat shrinkages. For example, shielding component 1₁ can be the PET material that contains UV-absorber, and/or luminescent component 2₁ can be the PBT material that contains red fluorescent material.

In the anti-counterfeit fiber shown in FIG. 1c and FIG. 1f, the flattening of the cross section of anti-counterfeit fiber is ≧1.5, for example, shielding component 1₁ can be PET material with UV absorber, and/or luminescent component 2₁ can be PET material that contains red photoluminescence material. Or shielding component 1₁ can be PEN material absorbing UV light, and/or luminescent 2₁ can be PET material that contains red fluorescent material.

Among the above materials, don't choose extinction material that could shield visible light.

When irradiated directly from angle B by the exciting light, shielding component 1₁ absorbs all the energy of the exciting light, which is equivalent to shielding the exciting light that should have directly irradiated to the adjacent luminescent component 2₁, Namely, shielding component 1₁ forms the shielding structure itself. At this time, the naked eye can not see the luminescence of anti-counterfeit fibers in every direction of observation. When irradiated directly from angle A by the exciting light, the exciting light irradiates directly to the luminescent component 2₁ and excites luminescence with luminescent color M which can penetrate the shielding components and can be seen by naked eye from all directions of observation of anti-counterfeit fibers.

In embodiment 1, the reason that luminescent component 2₁ exposes little on the surface of anti-counterfeit fiber is for the purpose of eliminating the influence of diffuse light of exciting light which is caused by diffuse reflection of paper fiber on the effect of optical color variable with irradiation angles as well as the influence of distortion of cross section of anti-counterfeit fibers caused by papermaking pressure on the effect of optical color variable with irradiation angles. For the reason that the less the exposure of a component on the surface, the better the emission intensity of this component, the oblate luminescent components 2₁ of anti-counterfeit fiber shown in FIGS. 1a, 1b, and/or 1c is better than the round luminescent components 2₁ of anti-counterfeit fiber shown in FIG. 1d and 1f in brightness, shield effect, elimination of the diffuse reflection of paper fiber, and/or elimination of the influence of papermaking pressure on the distortion of cross section of anti counterfeit fiber.

In this embodiment 1, the design of two-component compound anti-counterfeit fiber only can exhibit obvious visual difference of optical color between color M and no color.

### Embodiment 2

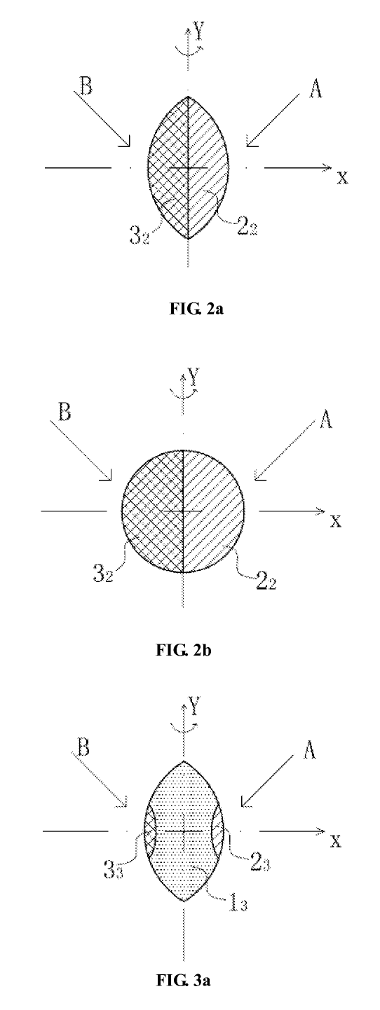

The fibers with cross sections as shown in FIG. 2a and FIG. 2b are parallel composed of the first luminescent component 2₂ and the second luminescent component 3₂. These two components are parallel distributed on the cross sections of anti-counterfeit fiber, and parallel extend in the longitudinal direction of the anti-counterfeit fiber without twisting. The cross-section flattening of anti-counterfeit fiber is ≦1, so said fiber is two-component curved fiber. The first luminescent component 2₂ contains photoluminescence material with luminescent color M. The second luminescent component 3₂ contains photoluminescence material with luminescent color N. And both of them have the same wavelength of exciting light, but luminescent color M and N are obviously different by naked eye. The two components locate respectively at the two sides of the Y axis of midperpendicular plane. The horizontal axis, X axis, of cross section equally divides the two parts located at midperpendicular plane. The areas of both the first luminescent component 2₂ and the second luminescent component 3₂ on the surface of the anti-counterfeit fiber are ½.

The luminescent component 2₂ can be PET materials with blue fluorescent material. The second luminescent component 3₂ can be PBT material with red fluorescent material. Don't add extinction fiber that can shield the visible light to the fluorescent material.

When irradiated directly from angle A by the exciting light, the first luminescent component 2₂ containing photoluminescence material displays luminescent color M, and uses up the energy of exciting light at the same time, thereby prevents the exciting light from irradiating to the second luminescent component 3₂ through the first luminescent component 2₂. This means the first luminescent component 2₂ which constitutes a shielding structure to prevent exciting light from irradiating to the second luminescent component 3₂, While luminescent color M can transmit in every direction of anti-counterfeit fiber through the second luminescent component 3₂ which is transparent, and can be seen by naked eye around said fiber. When irradiated directly from angle B, the second luminescent component 3₂ containing photoluminescence material displays luminescent color N and uses up the energy of exciting light at the same time, thereby prevents the exciting light from irradiating to the first luminescent component 2₂ through the second luminescent component 3₂. This means the second luminescent component 3₂ which constitutes a shielding structure to prevent exciting light from irradiating to the first luminescent component 2₂. While luminescent color N can transmit in every direction of anti-counterfeit fiber through the first luminescent component 2₂ which is transparent, and can be seen by naked eye around fiber.

It was proved by abundant experiments that this structure with two components of two luminescent colors exhibiting the effect of optical color variable with irradiation angles in embodiment 2 has week ability to eliminate the influence of the diffuse reflection of paper fiber on the effect of optical color variable with irradiation angles as well as influence of papermaking pressure on the distortion of cross section of anti counterfeit fiber. It is hard to get the effect of optical color variable with irradiation angles when there is high pressure in papermaking process or said anti-counterfeit fiber buried deeply in layer of paper pulp.

In embodiment 2, flattening of the two components fiber structures can be increased in order to eliminate diffuse reflection of paper fiber on the effect of optical color variable with irradiation angles as well as influence of papermaking pressure on the distortion of cross section of anti counterfeit fiber. But when the flattening is ≧1.2, the shelter ratio Z₄₅ is <70%, so it is hard to exhibit effect of optical color variable with irradiation angles when said fiber falls into layer of paper pulp. Thus this structure is of limited value in practice. In another word, this structure can not be used as effective exciting light shelter.

### Embodiment 3

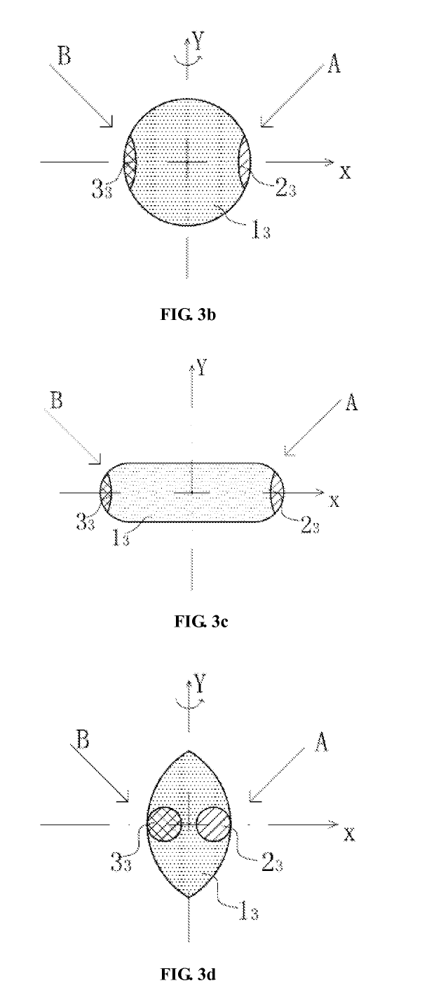

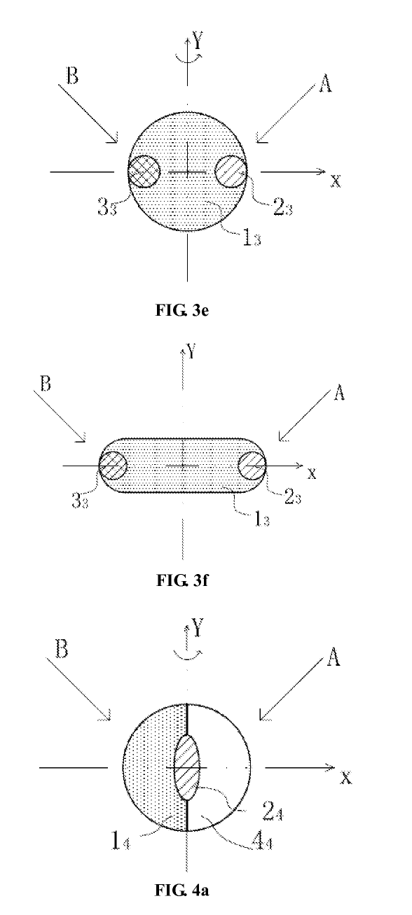

FIG. 3a, FIG. 3b, FIG. 3c, FIG. 3d, FIG. 3e and FIG. 3f show three-component anti-counterfeit fiber of which two components contain photoluminescence materials.

Said shielding component 1₃ is a light absorbing material which does not contain photoluminescence material and can be penetrable to visible light but shield the exciting light. The absorption spectrum of absorbing material covers the excitation wavelength of luminescent material. The first luminescent component 2₃ contains photoluminescence material with luminescent color M. The second luminescent component 3₃ contains photoluminescence material with luminescent color N. And both of them have the same wavelength of exciting light, but luminescent color M and N are obviously different by naked eye. On the cross-section of said fiber, the first luminescent component 2₃ and the second luminescent component 3₃ locate at two sides of Y axis. Preferably, said two luminescent components locate at two sides of Y axis symmetrically, of which portions on the cross sections of fiber are divided by X axis as shown in all figures of embodiment 3. The shielding component 1₃ is between said two luminescent components. These three components parallel extend along the length direction of anti-counterfeit fiber without twisting.

As shown in FIG. 3a, FIG. 3b, FIG. 3d and FIG. 3e, when the flattening of said anti-counterfeit fiber is ≦1, said anti-counterfeit fiber is curved, and the Y axises of every cross section of fibers turn to curved midperpendicular plane, along with which the anti-counterfeit fibers curve. Directional curved fiber is as same as said curved fiber, in which both the first luminescent component 2₃ and the second luminescent component 3₃ have the same heat shrinkage. In said fiber, the shielding component 1₃ is a PBT material with UV absorbing material, the first luminescent component 2₃ is a PBT material with blue fluorescent powder, as well as the second luminescent component 3₃ is a PET material with red fluorescent powder. In the above materials, the shielding component 1₃ can also be PEN material which is UV absorber itself. However, all three components can not choose extinction fiber material which shields visible light.

As shown in FIG. 3c and FIG. 3f, the flattening of anti-counterfeit fiber is ≧1.5, which is straight. The first luminescent component 2₃ and the second luminescent component 3₃ have same heat shrinkage. Shielding component 1₃ can be the PBT material with UV absorbing material, the first luminescent component 2₃ can be the PBT material with blue fluorescent powder, and the second luminescent component 3₃ can be the PBT material with red fluorescent powder. In above materials, the shielding component 1₃ can also be PEN material which is UV absorber itself. However, all three components can not choose extinction fiber material which shields visible light.

When irradiated directly from angle A by the exciting light, the first luminescent component 2₃, which contains the photoluminescence material, and shielding component 1₃ display luminescent color M and absorb energy of exciting light, which prevent the exciting light from irradiating to the second component 3₃ through the first luminescent component 2₃ and the shielding component 1₃. That means the shielding component 1₃ and the first luminescent component 2₃ constitute a shielding structure to shield exciting light irradiating to the second luminescent component 3₃. At this time, luminescent color M can transmit out and can be seen in every direction of observing anti-counterfeit fiber by naked eye. When irradiated directly from angle B by the exciting light, the second luminescent component 3₃, which contains the photoluminescence material, and shielding component 1₃ display luminescent color N and absorb energy of exciting light which prevent the exciting light from irradiating to the first component 2₃. That means the shielding component 1₃ and the second luminescent component 3₃ constitute a shielding structure to shield exciting light irradiating to the first luminescent component 2₃. At this time, luminescent color N can transmit out and can be seen in every direction of observing anti-counterfeit fiber by naked eye.

In embodiment 3, the anti-counterfeit fiber can exhibit excellent effect of optical color variable with irradiation angles and strongly eliminate the diffuse reflection of paper fiber when it has been pressed and distorted. The first and the second luminescent component 2₃ and 3₃, which both contain photoluminescence material, expose little on surface of fiber in order to eliminate diffuse reflection of paper fiber when the fiber falls into paper and the influence of paper pressure in the process of papermaking. The oblate first and second luminescent components 2₃ and 3₃ of anti-counterfeit fiber shown in FIGS. 3a, 3b, and/or 3c expose more area on the surface of said fiber than the round first and second luminescent components 2₃ and 3₃ of anti-counterfeit fiber shown in FIGS. 3d, 3e and/or 3f. The former is better than latter in brightness but worse in elimination of the diffuse reflection of paper fiber as well as elimination of the influence of papermaking pressure on the distortion of cross section of anti counterfeit fiber.

It was proved by abound experiments that three-component of composite spinning structure of said fiber described in embodiment 3 is better than two-component of composite spinning structure in eliminating the diffuse reflection of paper fiber as well as the cross section distortion caused by papermaking pressure on the effect of optical color variable with irradiation angles. So it is of practical value.

### Embodiment 4

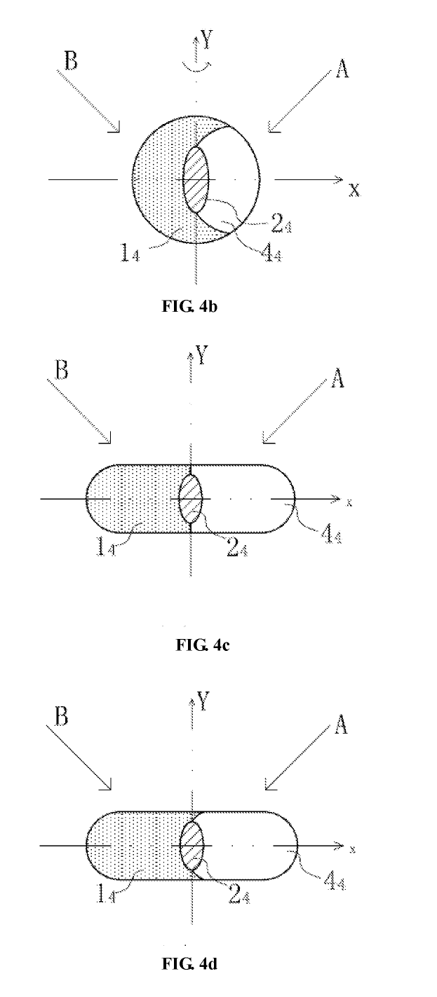

Cross-section of three-component anti-counterfeit fiber is shown in FIGS. 4a, 4b, 4c and 4d, which comprises shielding component 1₄, luminescent component 2₄ and transmitting component 4₄, which parallel stretch along with the direction of anti-counterfeit fiber length without twisting. The luminescent component 2₄ distributes between shielding component 1₄ and transmitting component 4₄ on cross-section of said fiber. In embodiment 4, preferably, the shielding component 1₄ and transmitting component 4₄ locate at the two sides of Y axis and are divided by Y axis equally. Meanwhile, these three components are divided by X axis equally. Luminescent 2₄ located at the center is also divided by Y axis. The shielding component 1₄ is an absorbing material which does not contain photoluminescence materials, can be penetrable to visible light but shield exciting light. Its absorption spectrum at least covers the excitation wavelength of luminescent material. Luminescent component 2₄ contains photoluminescence material whit luminescent color M. The transmitting component 4₄ can be penetrable to both exciting light and visible light. Preferably, on the cross-section of anti-counterfeit fiber, the shielding component 1₄ and/or transmitting component 4₄ are half round or half oblate respectively and are parallel composited. These two parts composite coordinately. Luminescent component 2₄ is in the middle of the interface of luminescent component 1₄ and transmitting component 4₄.

When the flattening of said anti-counterfeit fiber is ≦1 as shown in FIGS. 4a and 4b, said anti-counterfeit fiber is curved, the Y axises of every cross section of fibers turn to curved midperpendicular plane, along with which the anti-counterfeit fibers curve. Shielding component 1₄ and transmitting component 4₄ are materials with different heat shrinkages. Said shielding component 1₄ can be PBT material with UV absorbing material, said component 2₄ can be PBT material with red fluorescent powder and said transmitting component 4₄ can be bright transparent PET material. Said shielding component 1₄ can also be PEN material which is UV absorber itself. None of above components should choose extinction fiber which can shield visible light. Said transmitting component 4₄ can not choose bright PEN material, because PEN material can absorb UV light, although it can be penetrable to visible light.

When the flattening of said anti-counterfeit fiber is ≧1.5 as shown in FIGS. 4c and 4d, said anti-counterfeit fiber is straight fiber. Said shielding component 1₄ has the same heat shrinkage with said transmitting component 4₄. Said shielding component 1₄ can be PBT material with UV absorbing material, said luminescent component 2₄ can be PBT material with red fluorescent powder and said transmitting component 4₄ can be bright transparent PBT material. Said shielding component 1₄ can also be PEN material which is UV absorber itself. None of above components should choose extinction fiber which can shield visible light. Said transmitting component 4₄ can not choose bright PEN material, because PEN material can absorb UV light, although it can be penetrable to visible light.

When irradiated from the angle of B by the exciting light, said shielding component 1₄ absorbs the energy of exciting light completely, which is equivalent to shielding the exciting light that should have directly irradiated to the adjacent luminescent component 2₄. At this time, the naked eye can not see the luminescence of anti-counterfeit fibers in all directions of observation. When the exciting light irradiates from the angle of A, the exciting light irradiates directly to the luminescent component 2₄ through the transmitting compound 4₄, and excites luminescence with luminescent color M which can penetrate the shielding components 1₄ and transmitting compound 4₄, at this time, the naked eye can see the luminescence of anti-counterfeit fibers in every direction of observation.

This structure of said anti-counterfeit fiber can strongly eliminate the influence of diffuse reflection of paper fiber. Even though said anti-counterfeit fiber is distorted by the pressure of papermaking, it still exhibits excellent effect of optical color variable with irradiation angles. Furthermore, under the papermaking pressure, the transmitting component 4₄ can combine with paper fiber tightly which can be transparent. Consequently, it avoids the diffuse reflection of paper fiber around luminescent component 2₄.

### Embodiment 5

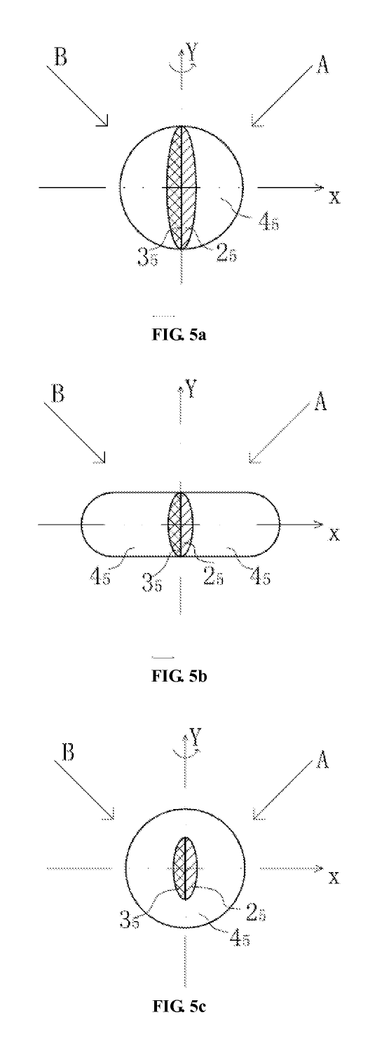

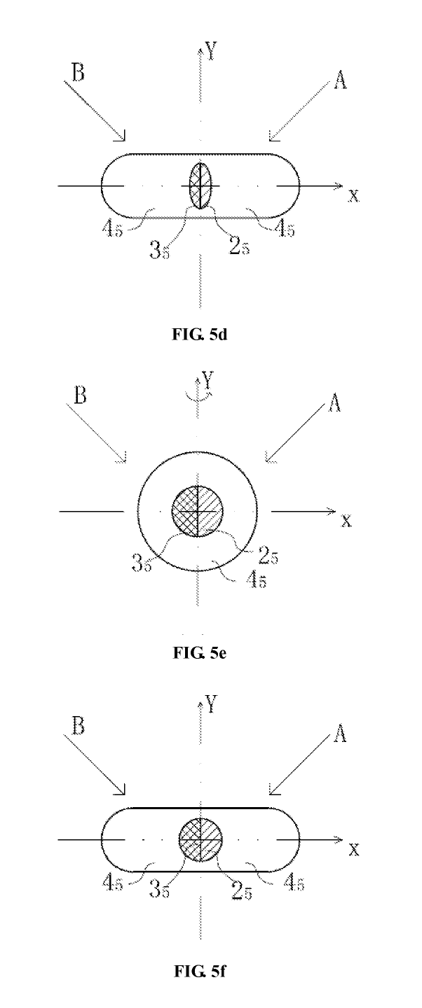

Cross-section of three-component anti-counterfeit fiber is shown in FIGS. 5a, 5 b, 5 c, 5d, 5e and 5f, which is composed of a component of transparent material as well as two components of photoluminescence materials. These three components parallel extend to the direction of anti-counterfeit fiber length without twisting. Said anti-counterfeit fiber consists of the first luminescent component 2₅, the second luminescent component 3₅ and transmitting component 4₅. The first luminescent component 2₅, contains photoluminescence material with luminescent color M. The second luminescent component 3₅, contains photoluminescence material with luminescent color N. And both of them have the same wavelength of exciting light, but luminescent color M and N are obviously different by naked eye. Transmitting component 4₅ can be penetrable to exciting light and visible light. On the cross-section of anti-counterfeit fiber, the transmitting component 4₅ is round or oblate, and the first luminescent component 2₅ and/or the second luminescent component 3₅ which is half round or half oblate respectively parallel composite circle or ellipse, which locates in the middle of the round or oblate shielding component 4₅. When the profile of transmitting component 4₅ is oblate, its long axis is parallel to X axis. The interface of the first luminescent component 2₅ and the second luminescent component 3₅ shall vertical with axis X. Preferably, the interface of the first luminescent component 2₅ and the second luminescent component 3₅ shall be divided by Y axis equally, and all components shall be divided by X axis equally.

In the anti-counterfeit fiber shown in FIG. 5a, FIG. 5c, and FIG. 5e, the flattening of the cross section of anti-counterfeit fiber is ≦1. said anti-counterfeit fiber is curved, the Y axises of every cross section of fibers turn to curved midperpendicular plane, along with which the anti-counterfeit fibers curve. The first luminescent component 2₅ and the second luminescent component 3₅ have different heat shrinkages. The first luminescent component 2₅ can be the PEN material with blue fluorescent powder, the second luminescent component 3₅ can be the PEN material with red fluorescent powder and the transmitting component 4₅ can be the bright PP transparent material in which the hardness of PP is far lower than that of the PEN and PET. All of these components can not choose extinction fiber material which shields visible light. In addition, transmitting component 4₅ can not choose the bright PEN transparent material which can absorb UV light although it can be penetrable to visible light.

In the anti-counterfeit fiber shown in FIG. 5b, FIG. 5d, and FIG. 5f, the flattening is said anti-counterfeit fiber is straight fiber. The first luminescent component 2₅ can be the PEN material with blue fluorescent powder, the second luminescent component 3₅ can be the PEN material with red fluorescent powder and the transmitting component 4₅ can be the bright PBT transparent material. All of these components can not choose extinction fiber material which shields visible light. In addition, transmitting component 4₅ can not choose the bright PEN transparent material which can absorb UV light although it can be penetrable to visible light.

When the exciting light irradiates from the angle of A, it irradiates the first luminescent component 2₅ through the transmitting component 4₅. The photoluminescence materials of the first luminescent component 2₅ displays the luminescent color M and absorbs the energy of the exciting light, which prevents the exciting light from irradiating to the second component 3₅ through the first luminescent component 2₅. That means the first luminescent component 2₅ constitutes a shielding structure to shield exciting light irradiating to the second luminescent component 3₅. At this time, luminescent color M can transmit out and can be seen in every direction of observing anti-counterfeit fiber by naked eye. When the exciting light irradiates from the angle of B, it irradiates the second luminescent component 3₅ through the transmitting component 4₅. The photoluminescence materials of the second luminescent component 3₅ displays the luminescent color N and absorbs the energy of the exciting light, which prevents the exciting light from irradiating to the first component 2₅ through the second luminescent component 3₅. That means the second luminescent component 3₅ constitutes a shielding structure to shield exciting light irradiating to the first luminescent component 2₅. At this time, luminescent color N can transmit out and can be seen in every direction of observing anti-counterfeiting fiber by naked eye.

This structure of embodiment 5 shown in FIGS. 5a and 5b can strongly eliminate the influence of diffuse reflection of paper fiber. Even though said anti-counterfeit fiber is distorted by the pressure of papermaking, it still exhibits excellent effect of optical color variable with irradiation angles. Furthermore, under pressure of papermaking, oblate cross section composed of the first luminescent component 2₅ and the second luminescent component 3₅ is still oblate, at most is circle, which is still concave and convex shelter. Consequently, it avoids the diffuse reflection of paper fiber around luminescent component 2₄. Furthermore, under the papermaking pressure, the transmitting component 4₅ can combine with paper fiber tightly which can be transparent. Consequently, it avoids the diffuse reflection of paper fiber around the first luminescent component 2₅ and the second luminescent component 3₅ on the direction of exciting light.

In embodiment 5 shown in FIGS. 5c and 5d, the first luminescent component 2₅ and the second luminescent component 3₅ locate in the center of transmitting component 4₅. This structure can strongly eliminate the influence of diffuse reflection of paper fiber. Even though said anti-counterfeit fiber is distorted by the pressure of papermaking, it still exhibits excellent effect of optical color variable with irradiation angles. Furthermore, when the transmitting component 4₅ is relatively softer than the first luminescent component 2₅ and the second luminescent component 3₅, the softer the transmitting component 4₅ is distorted prior to the first luminescent component 2₅ and the second luminescent component 3₅ under pressure of papermaking, while the first luminescent component 2₅ and the second luminescent component 3₅ are not or a little distorted. Furthermore, under the papermaking pressure, the transmitting component 4₅ can combine with paper fiber tightly which can be transparent. Consequently, it avoids the diffuse reflection of paper fiber around the first luminescent component 2₅ and the second luminescent component 3₅ on the direction of exciting light.

The structure of embodiment 5 shown in the FIGS. 5e and 5f is similar with above structure of embodiment 5. The difference is that, on the cross-section of the anti-counterfeiting fiber, the first luminescent component 2₅ and/or the second luminescent component 3₅ which is half round or half oblate respectively parallel composite circle. This structure makes spinning easily. Such function of the structure is quite similar to that of the structure mentioned above in the embodiment 5.

### Embodiment 6

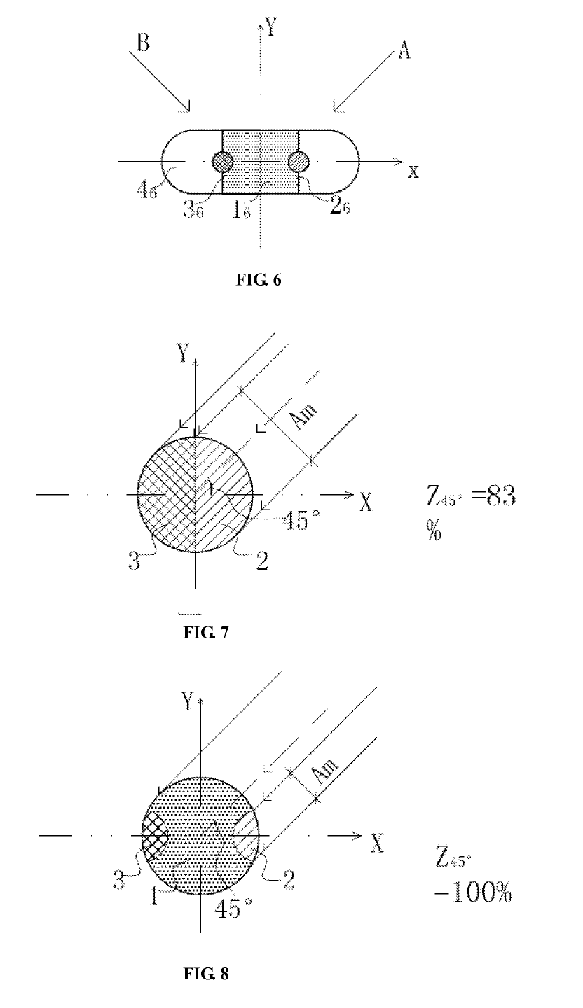

The anti-counterfeiting fiber whose cross-section is shown in FIG. 6 is curved fiber. It comprises shielding component 1₆, the first luminescent component 2₆, the second luminescent component 3₆ and transmitting component 4₆. These four components are parallel distributed on the cross sections of anti-counterfeit fiber, and parallel extend in the longitudinal direction of the anti-counterfeit fiber without twisting. Said shielding component 1₆ without photoluminescence material in which the absorption spectrum of absorbing material at least covers the excitation wavelength of the luminescent material. The first luminescent component 2₆ contains photoluminescence materials with the luminescent color M. The second luminescent component 3₆ contains photoluminescence materials with the luminescent color N. The photoluminescence materials in first luminescent component 2₆ and in the second luminescent component 3₆ have the same exciting light wavelength. But luminescent M and luminescent N display obvious visual difference. The transmitting component 4₆ can be penetrable to both exciting light and visible light. The shielding component 1₆ locates between the two parts of the transmitting component 4₆ and they are parallel to compose two interfaces. Said interfaces are vertical to X axis. The first luminescent component 2₆ and the second luminescent component 3₆ respectively locate in the middle of the two interfaces. Preferably, the structures of all these four components are divided by X axis and Y axis equally.

When the exciting light irradiates from the angle of A, the exciting light irradiates directly to the first luminescent component 2₆ through the transmitting compound 4₆, and excites luminescence with luminescent color M. The first luminescent component 2₆ and shielding component 1₆ absorb energy of exciting light, which prevent the exciting light from irradiating to the second component 3₆ through the first luminescent component 2₆ and the shielding component 1₆. That means the shielding component 1₆ and the first luminescent component 2₆ constitute a shielding structure to shield exciting light irradiating to the second luminescent component 3₆. At this time, luminescent color M can transmit out and can be seen in every direction of observing anti-counterfeit fiber by naked eye. When the exciting light irradiates from the angle of B, the exciting light irradiates directly to the second luminescent component 3₆ through the transmitting compound 4₆, and excites luminescence with luminescent color N. The second luminescent component 3₆ and shielding component 1₆ absorb energy of exciting light, which prevent the exciting light from irradiating to the first component 2₆ through the second luminescent component 3₆ and the shielding component 1₆. That means the shielding component 1₆ and the second luminescent component 3₆ constitute a shielding structure to shield exciting light irradiating to the first luminescent component 2₆. At this time, luminescent color N can transmit out and can be seen in every direction of observing anti-counterfeit fiber by naked eye

This structure of said anti-counterfeit fiber in embodiment 6 can strongly eliminate the influence of diffuse reflection of paper fiber. Even though said anti-counterfeit fiber is distorted by the pressure of papermaking, it still exhibits excellent effect of optical color variable with irradiation angles. Advisably, the middle shielding component 1₆ can absorb the diffuse reflection of surrounding paper fiber. Furthermore, under the papermaking pressure, the two parts of transmitting component 4₆ at the two sides can combine with paper fiber tightly which can be transparent.

Generally, the length of the anti-counterfeiting fiber mentioned above is no longer than 8 mm, the width D of the cross-section is no longer than 250 um and the height of the cross-section is no larger than 120 um.

### The Embodiment 7

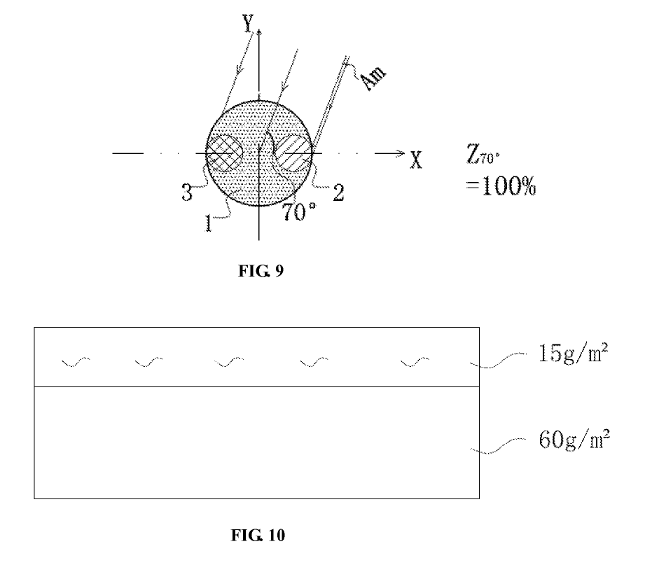

The FIG. 10 shows an anti-counterfeiting paper with two pulp-layers structure containing said anti-counterfeiting fiber mentioned above, characterized in, the ration of upper paper pulp and lower paper pulp are 15 g/m² and 60 g/m², respectively. Said anti-counterfeit fiber locates in the upper pulp layer. When irradiated on the upper surface of the upper pulp layer by exciting light, the anti-counterfeiting fiber exhibits the anti-counterfeiting effect.

1-16. (canceled)

17. A fluorescent anti-counterfeit fiber, which comprises at least two components distributing on the cross section of said fiber and parallel extending along with the direction of the fiber length without twisting, in which at least one of said components contains photoluminescent material, characterized in that, the distributing of the at least two components of said anti-counterfeit fibers on said cross section of said anti-counterfeit fiber makes said anti-counterfeit fiber constitute exciting light shielding structure which can shield the exciting light and directional structure with specific orientation, both of which enable, when said anti-counterfeit fiber falls freely into a plane paralleled to the horizontal plane, the existence of at least two irradiation angles, called angle A and angle B respectively, of exciting light above said plane paralleled to the horizontal plane, from which exciting light irradiates on said anti-counterfeit fiber respectively, and thereby said anti-counterfeit fiber displays obvious visual difference between two different luminescent colors, all components of said anti-counterfeit fiber are transparent to visible light in order that said obvious visual difference of luminescent color/colors can be seen in every observing direction of said anti-counterfeit fiber by naked eye, and said obvious visual difference at least is in one of the following two situations:
When irradiated from angle A by exciting light, said anti-counterfeit fiber displays a luminescent color, called luminescent color M, while said anti-counterfeit fiber is irradiated from angle B, said luminescent color disappears,
When irradiated from angle A by exciting light, said anti-counterfeit fiber displays luminescent color M, while irradiated from angle B by exciting light, anti-counterfeit fiber displays another luminescent color, called luminescent color N, wherein luminescent color M and N display obvious visual difference.

18. Said fluorescent anti-counterfeit fiber according to claim 17, characterized in that, setting a plane coordinates with the horizontal X axis and vertical Y axis, which uses the geometric center of the cross section of the anti-counterfeit fiber as its origin, when only one component of the anti-counterfeit fiber contains photoluminescence material, said component containing photoluminescence material is distributed at the left or right side of midperpendicular plane composed of all Y axises and is divided symmetrically by the X axis; however, when two components of the anti-counterfeit fiber contain different photoluminescence materials, said two components containing different photoluminescence materials are distributed at the left and the right sides of midperpendicular plane composed of all Y axises respectively and are both divided symmetrically by the X axis, wherein said two components have the same wavelength of exciting light but display obviously different luminescent colors.

19. The fluorescent anti-counterfeit fiber according to claim 17, characterized in that, when the flattening of the anti-counterfeit fiber is less than 1.5, said anti-counterfeit fiber is curved, and the Y axises of all cross-sections of fibers turn to curved midperpendicular plane composed of Y axises, along with which the anti-counterfeit fibers curve, thus at least two components of said anti-counterfeit fiber with different heat shrinkages need to locate at the two sides of the midperpendicular plane composed of Y axises respectively in order to directionally curve anti-counterfeit fibers along with the midperpendicular plane composed of Y axises; or when the flattening of the anti-counterfeit fiber is more than or equal to 1.5, said anti-counterfeit fiber is straight, thus the heat shrinkages of all components of anti-counterfeit fiber or at least the components distributing symmetrically are the same in order to make anti-counterfeit fiber straight.

20. The fluorescent anti-counterfeit fiber according to claim 18, characterized in that, when the flattening of the anti-counterfeit fiber is less than 1.5, said anti-counterfeit fiber is curved, and the Y axises of all cross-sections of fibers turn to curved midperpendicular plane composed of Y axises, along with which the anti-counterfeit fibers curve, thus at least two components of said anti-counterfeit fiber with different heat shrinkages need to locate at the two sides of the midperpendicular plane composed of Y axises respectively in order to directionally curve anti-counterfeit fibers along with the midperpendicular plane composed of Y axises; or when the flattening of the anti-counterfeit fiber is more than or equal to 1.5, said anti-counterfeit fiber is straight, thus the heat shrinkages of all components of anti-counterfeit fiber or at least the components distributing symmetrically are the same in order to make anti-counterfeit fiber straight.

21. Said fluorescent anti-counterfeit fiber according to claim 18, characterized in that, said fluorescent anti-counterfeit fiber comprises the shielding component (1₁) and the luminescent component (2₁), said shielding component (1₁) which does not contain photoluminescence material can be penetrable to visible light but shield the exciting light, and said luminescent component (2₁) which contains photoluminescence material displays luminescent color M, wherein the superficial area of luminescent component (2₁) on the surface of anti-counterfeit fiber is not larger than ⅖ of the whole fiber superficial area; wherein when the flattening of said anti-counterfeit fiber is <1.5, said anti-counterfeit fiber is curved, the Y axises of all cross-sections of fibers turn to curved midperpendicular plane composed of Y axises, along with which the anti-counterfeit fibers curve, thus shielding component (1₁) and luminescent component (2₁) have different heat shrinkages in order to directionally curve anti-counterfeit fibers; or when the flattening of said anti-counterfeit fiber is ≧1.5, said anti-counterfeit fiber is straight, thus shielding component (1₁) and luminescent component (2₁) have the same heat shrinkage in order to make the anti-counterfeit fiber straight.

22. Said fluorescent anti-counterfeit fiber according to claim 18, characterized in that, said anti-counterfeit fiber comprises the first luminescent component (2₂) and the second luminescent component (3₂) by means of parallel combining of said two luminescent components, in which said first luminescent component (2₂) contains photoluminescence material with luminescent color M and said second luminescent component (3₂) contains photoluminescence material with luminescent color N, in which luminescent color M and N display obvious visual difference, in which said two components containing photoluminescence material have the same wavelength of exciting light, wherein the superficial area of the first luminescent component (2₂) and the second luminescent component (3₂) on the surface of the anti-counterfeit fiber are ½ of the total superficial area respectively; when the flattening of anti-counterfeit fiber is <1.5, said anti-counterfeit fiber is curved, and the Y axises of all cross-sections of fibers turn to curved midperpendicular plane composed of Y axises, along with which the anti-counterfeit fibers curve, the first luminescent component (2₂) and the second luminescent component (3₂) have different heat shrinkages in order to directionally curve anti-counterfeit fibers, or when the flattening of the anti-counterfeit fiber is more than or equal to 1.5, said anti-counterfeit fiber is straight, thus the first luminescent component (2₂) and the second luminescent component (3₂) have the same heat shrinkage in order to make anti-counterfeit fiber straight.

23. Said fluorescent anti-counterfeit fiber according to claim 18, characterized in that, said anti-counterfeit fiber comprises the shielding component (1₃), the first luminescent component (2₃) and the second luminescent component (3₃), in which said shielding component (1₃) which does not contain photoluminescence material can be penetrable to visible light but shield the exciting light, said first luminescent component (2₃) contains photoluminescence material with luminescent color M, and said second luminescent component (3₃) contains photoluminescence material with luminescent color N, in which luminescent color M and N display obvious visual difference; wherein when the flattening of anti-counterfeit fiber is less than 1.5, said anti-counterfeit fiber is curved, and the Y axises of all cross-sections of fibers turn to curved midperpendicular plane composed of Y axises, along with which the anti-counterfeit fibers curve, wherein the first luminescent component (2₃) and the second luminescent component (3₃) have different heat shrinkages in order to curve the anti-counterfeit fibers along with the midperpendicular plane composed of Y axises, or when the flattening of said anti-counterfeit fiber is larger than or equal to 1.5, said anti-counterfeit fiber is straight, at least the first luminescent component (2₃) and the second luminescent component (3₃) have the same heat shrinkage in order to make anti-counterfeit fiber straight.

24. Said fluorescent anti-counterfeit fiber according to claim 17, characterized in that, said anti-counterfeit fiber comprises shielding component (1₄), luminescent component (2₄) and transmitting component (4₄), in which said shielding component (1₄) does not contain photoluminescence material and is penetrable to visible light but shield the exciting light, said luminescent component (2₄) contains photoluminescence material with luminescent color M, and said transmitting component (4₄) is penetrable to exciting light as well as visible light, wherein on cross-section of said anti-counterfeit fiber, profiles of shielding component (1₄) and transmitting component (4₄) are semicircle or semi-oblate respectively, which are parallel arranged together with the luminescent component (2₄) in the middle of shielding component (1₄) and transmitting component (4₄); wherein when the flattening of said anti-counterfeit fiber is less than 1.5, said anti-counterfeit fiber is curved, and the Y axises of all cross-sections of fibers turn to curved midperpendicular plane composed of Y axises, along with which the anti-counterfeit fibers curve, thus the shielding component (1₄) and transmitting component (4₄) have different heat shrinkages in order to directionally curve anti-counterfeit fibers along with the midperpendicular plane composed of Y axises; or when the flattening of said anti-counterfeit fiber cross-section is more than or equal to 1.5, said anti-counterfeit fiber is straight, thus at least the shielding component (1₄) and the transmitting component (4₄) have the same heat shrinkage in order to make said anti-counterfeit fiber straight.

25. Said fluorescent anti-counterfeit fiber according to claim 17, characterized in that, said anti-counterfeit fiber comprises the first luminescent component (2₅), the second luminescent component (3₅) and transmitting component (4₅), in which said first luminescent component (2₅) contains photoluminescence material with luminescent color M and said second luminescent component (3₅) contains photoluminescence material with luminescent color N, in which the two luminescent components (2₅) and (3₅) have the same wave length of exciting light, and luminescent color M and N with the same wavelength of exciting light however display obvious visual difference, and said transmitting component (4₅) is penetrable to exciting light as well as visible light; wherein on cross-section of said anti-counterfeit fiber, profiles of the first luminescent component (2₅) and the second luminescent component (3₅) are semi-oblate respectively and parallel arranged together to a whole oblate, and the profile of transmitting component (4₅) is circle or oblate, in which the oblate profile pieced of the first luminescent component (2₅) and the second luminescent component (3₅) is medially contained in the center of circle or oblate profile of transmitting component (4₅), in which the long axis of oblate transmitting component (4₅) is parallel to X-axis, and the interface of the first luminescent component (2₅) and the second luminescent component (3₅) is vertical to X-axis; wherein when the flattening of anti-counterfeit fiber is less than 1.5, said anti-counterfeit fiber is curved, and the Y axises of all cross-sections of fibers turn to curved midperpendicular plane composed of Y axises, along with which the anti-counterfeit fibers curve, thus the first luminescent component (2₅) and the second luminescent component (3₅) have different heat shrinkages in order to directionally curve anti-counterfeit fibers; or when the flattening of said anti-counterfeit fiber is larger than or equal to 1.5, said anti-counterfeit fiber is straight, thus at least the first luminescent component (2₅) and the second luminescent component (3₅) have the same heat shrinkage in order to make anti-counterfeit fiber straight.

26. An anti-counterfeit material containing fluorescence anti-counterfeit fiber, said anti-counterfeit material is paper or plastic film, characterized in that, said anti-counterfeit fiber of said fluorescence anti-counterfeit material is composed of components with different optical properties, in which proper selections of structure distribution of components on said cross-section of said fluorescence anti-counterfeit fiber composing said anti-counterfeit material, optical properties of all components and the relative position between the cross section of said anti-counterfeit fiber and the surface of said anti-counterfeit material give rise to at least two irradiation angles of the exciting light on a surface, in which exciting light irradiating the same anti-counterfeit fiber of said anti-counterfeit material from said two irradiation angles causes obvious visual difference.

27. Said anti-counterfeit material containing fluorescent anti-counterfeit fiber according to claim 26, characterized in that, said anti-counterfeit material contains fluorescent anti-counterfeit fiber according to any of claims 17 to 25.
